(19) United States
(12) Patent Application Publication
(10) Pub. No.: US 2015/0204370 A1
(43) Pub. Date: Jul. 23, 2015

(54) EARTH BOLT

(71) Applicant: TOYOTA JIDOSHA KABUSHIKI KAISHA, Toyota-shi (JP)

(72) Inventor: Yoshihisa SERIZAWA, Shizuoka-ken (JP)

(73) Assignee: TOYOTA JIDOSHA KABUSHIKI KAISHA, Toyota-shi (JP)

(21) Appl. No.: 14/596,493

(22) Filed: Jan. 14, 2015

(30) Foreign Application Priority Data
Jan. 22, 2014 (JP) 2014-009350

(51) Int. Cl. F16B 33/00

(52) U.S. Cl. CPC F16B 33/004; F16B 33/00

(57) ABSTRACT

An earth bolt is electrically connected to a nut and an earth terminal, by being engaged in the nut to position the earth terminal between the bolt and the nut. The bolt has a head and a body, the body extending from the head and having threads of an external thread formed on the body and screw-fastened to an internal thread of the nut. Among the flank surfaces formed on the thread, a convex portion is formed on a head-facing flank surface, the head-facing flank surface facing the head, along a circumference centering a shaft center of the body in such a manner that the convex portion is protruded from the head-facing flank surface. A top surface parallel to the head-facing flank surface is formed on the convex portion in a position where the convex portion interests with a pitch line of the earth bolt.

The disclosure of Japanese Patent Application No. 2014-009350 filed on Jan. 22, 2014 including the specification, drawings and abstract is incorporated herein by reference in its entirety.

### BACKGROUND OF THE INVENTION

1. Field of the Invention

The invention relates to an earth bolt, as a bolt engaged in a nut, adapted for electrical connection to a nut.

2. Description of Related Art

There are cases where a bolt is engaged in a nut screw-fastened to an external thread formed on the body of the bolt to an internal thread of the nut. For example, there are cases where an earth bolt (hereinafter, “bolt”) is used for grounding via the earth terminal, etc. Specifically, when the bolt is used, the bolt is engaged in a nut such that the earth terminal is positioned between the head of the bolt and the nut together with a base material (i.e. automobile body) that becomes reference potential. Accordingly, the current flowing through the earth terminal can flow into the base material through the bolt and the nut. At that time, in order to flow the current properly, it would be preferable for not only the part where the earth terminal and the head of the bolt are in contact with each other, but also the engaging portion of the bolt and the nut (screw-fastened portion) is electrically connected.

As an example where the earth bolt is adapted, in case a base material to which the nut is welded is coated with an insulating coating film by painting, etc., the earth bolt and the nut are engaged from both sides of the base material and the earth terminal such that the earth terminal can be positioned between the head of the bolt and the coated base material.

Accordingly, even if the current does not directly flow from the earth terminal to the base material by having the base material coated with the insulating coating film, the current flowing through the earth terminal flows from the head of the bolt electrically connected to the earth terminal to the body of the bolt. The current flowing through the body of the bolt flows from the body of the bolt to the nut engaged thereto. Here, since the nut is welded on the base material, the current flowing through the nut can flow into the base material. Even in these circumstances, it is important for the bolt and the nut to be electrically connected in the engaging portion.

As an example of this technology, a bolt is described in the following as a suggestion. The bolt has a head and a body, the body extending from the head and forming a thread of an external thread screw-fastened on an internal thread of the nut, wherein a protrusion protruding outward is formed on a flank surface near the top part of the thread formed on the body (for example, Japanese Patent Application Publication No. 2012-219854, Japanese Patent Application Publication No. 2001-173627).

By forming the protrusion as above, the protrusion formed on the top part of the thread of the bolt is engaged in the nut during engaging and the bolt and the nut can be electrically connected through the engaging portion.

Also, in JP 2001-173627 A, by forming a convex portion partially on the screw of the taper on the end of the body, the coating film formed on the internal thread of the nut can be stripped by the convex portion before being engaged in the engaging portion.

However, any protrusion formed on the bolt in JP 2012-219854 A and JP 2001-173627 A mentioned above is sharply formed like a spot only at a region near the top part of the thread. As a result, this protrusion is the part where the nut and the bolt are in metallic contact with each other in the engaging portion of the bolt. Accordingly, as the contact area (the metallic area contacting with metal) of the nut and the bolt gets smaller, there is a possibility that the area where a current flows between the nut and the bolt would not be sufficiently secured.

In particular, when forming a thread by form rolling, etc., since dimensional tolerance near the top part of the thread is large, there are cases where even protrusions formed near the thread might not have a desired height sufficient for contacting the surface of the screw groove of the nut. Due to this, the contact area of the nut and the bolt gets remarkably smaller in the engaged state than that anticipated at the time of designing.

As such, if the area where a current flows between the nut and the bolt (contact area) is small, the electric resistance between the nut and the bolt increases. If a high current flows from the earth terminal, there is a possibility that abnormal heating would generate at this area.

### SUMMARY OF THE INVENTION

The present invention provides an earth bolt properly flowing a current to the part engaged in the nut by increasing contact area with the nut in the state of engaging the bolt to the nut.

In order to solve the above matter, as a result of making a close review, the inventors have come up with a pitch line. Here, the pitch line is by definition the generator of a virtual cylinder used to define an effective diameter. An effective diameter means the diameter of a virtual cylinder where the width of the screw groove becomes equal to the width of the thread. That is, on the pitch line, the thread of the bolt surely contacts with the screw groove of the nut. Also, the inventors found that the area in electric connection to the nut can be increased by forming a convex portion having a larger contact area with the nut on the flank surface of the thread located on the pitch line.

In an aspect of the present invention, the earth bolt according to the present invention is an earth bolt for coming into electrical contact with a nut by being engaged in the nut, the earth bolt including a head and a body, the body extending from the head, the body having threads of an external thread formed on the body and screw-fastened to an internal thread of the nut, wherein flank surfaces are formed on the thread, a convex portion is formed on a head-facing flank surface, the head-facing flank surface facing the head, along a circumference centering a shaft center of the body in such a manner that the convex portion is protruded from the head-facing flank surface, and wherein a top surface parallel to the head-facing flank surface is formed on the convex portion in a position where the convex portion interacts with the pitch line of the earth bolt.

According to an aspect of the present invention, when the earth bolt (hereinafter, “bolt”) is engaged in the nut, shaft force is applied on the body of the bolt along the direction of the shaft center of the head side. Thus, among the flank surfaces forming the thread, surface pressure is applied from the nut on the head-facing flank surface facing the head. Thus, in an aspect of the present invention, by forming a convex portion at a position at which the convex portion interests with the pitch line of the earth bolt on the head-facing flank surface, regardless of the dimensional tolerance during manufacturing, the thread of the bolt can surely contact (metallic contact) with the screw groove of the nut screw-fastened thereto.

Such convex portion is formed along a circumference centering the shaft center of the body in a position where the convex portion intersects with the pitch line. The convex portion is continuously formed in a spiral on a virtual cylinder where the width of the screw groove of the nut becomes equal to the width of the thread of the bolt. As a result thereof, the contact area around the shaft center of the body of the bolt can be stably increased.

Also, a top surface parallel to the head-facing flank surface is formed on the convex portion at the intersecting position with the pitch line of the earth bolt. Thus, the top surface of the convex portion of the body of the bolt can be in surface contact with the surface (flank surface) of the screw groove of the nut in the inclination direction of the thread without excessively cutting off the nut by the convex portion.

As a result thereof, in the state that the bolt is engaged in the nut so as to position the earth terminal between the bolt and the nut, the resistance of the engaging portion can be reduced such that the current can properly flow from the earth terminal by increasing the contact area with the nut.

However, the inventors found that in case of adopting the engaging method for being engaged in a nut so as to position a conductive member such as an earth terminal, etc. between the bolt and the nut, the nut in the engaged state bends as a whole. As a result, the hole of the nut in the engaging surface side increases. Therefore, the inventors have thought that, during engaging, as the nut proceeds to the head side of the bolt, the surface pressure being applied on the head-facing flank surface on the thread of the bolt gets smaller (as the load share of the load being applied along the direction of the shaft center gets smaller). The state in which the bolt and the nut are engaged gets unstable.

In light of the above, the height of the convex portion from the head-facing flank surface which is on a bolt head side may be formed to be higher. According to this aspect, in the engaged state the bolt to the nut so as to position the earth terminal between the bolt and the nut, even if the nut in the engaged state bends as a whole and the hole of the nut in the engaging surface side slightly increases, the surface pressure being applied on the flank surface of the thread of the bolt can be equalized by forming a convex portion having a height as mentioned in the above. Accordingly, the state of contacting the bolt with the nut can be stabilized.

When the earth bolt strips a coating film formed on the internal thread of the nut while it is engaged in the nut, the height of the convex portion from the head-facing flank surface may be greater than a thickness of the coating film.

By forming a convex portion having the above height, the top surface of the convex portion can be in metallic contact with the surface (flank surface) of the internal thread of the stripped portion, while stripping the coating film of the internal thread of the nut.

Also, with regard to the nut formed with a coating film on the internal thread of the nut, a concave groove portion may be formed on the body along the direction of the shaft center of the body, the concave groove portion extending to an end of the body.

According to this aspect, when the bolt is engaged in the nut, the coating film formed on an internal thread of the nut is stripped by the convex portion, and the stripped coating film may be discharged from the concave groove towards the end of the body of the bolt.

Also, a hard coating harder than the nut may be formed on at least the head-facing flank surface which is closer to the end side of the body than the engaging portion to be engaged in the nut. According to this aspect, when the bolt is engaged in the nut, a part of the coating film coated on the nut can be stripped in advance without cutting off the coating coated on the head-facing flank surface by the nut.

According to an aspect of the present invention, the contact area with the nut can increase in the state that the bolt is engaged in the nut, thereby properly flowing the current to the part engaged in the nut.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic side view of an earth bolt in accordance with Embodiment 1 of the present invention;

FIG. 2A is a schematic cross-sectional view of an earth bolt shown in FIG. 1;

FIG. 2B is an enlarged view of Part A shown in FIG. 2A;

FIG. 2C is an enlarged view illustrating a part of Part B shown in FIG. 2A;

FIG. 3 is a drawing illustrating the state where the earth bolt shown in FIG. 1 is engaged in a nut;

FIG. 4 is an enlarged cross-sectional view illustrating a part of the engaging portion of the earth bolt and a nut shown in FIG. 3;

FIG. 5A is a schematic cross-sectional view of an earth bolt in accordance with Embodiment 2 of the present invention;

FIG. 5B is an enlarged view of Part C shown in FIG. 5A.

FIG. 6A is a photograph of a state that a bolt and a nut are engaged according to Example 1.

FIG. 6B is a photograph of a state that a bolt and a nut are engaged according to Comparative Example 1.

FIG. 6C is a photograph of a state that a bolt and a nut are engaged at a position different from the position shown in FIG. 6B.

### DETAILED DESCRIPTION OF EMBODIMENTS

Hereinafter, embodiments of the present invention are explained with reference to the drawings.

### Embodiment 1

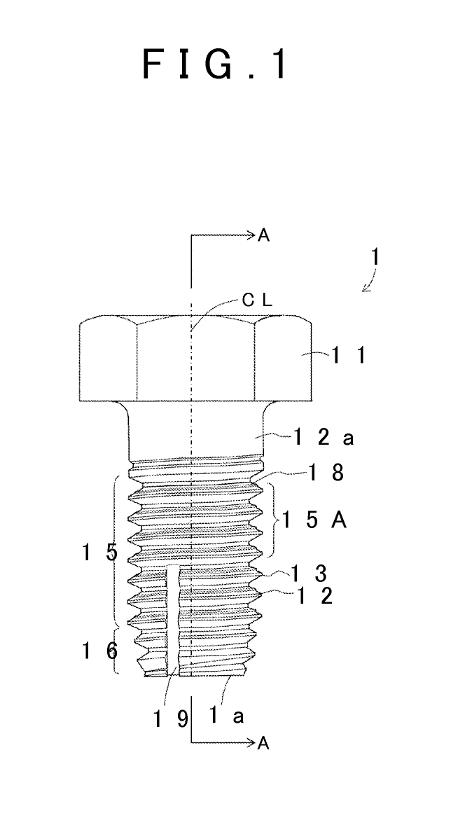

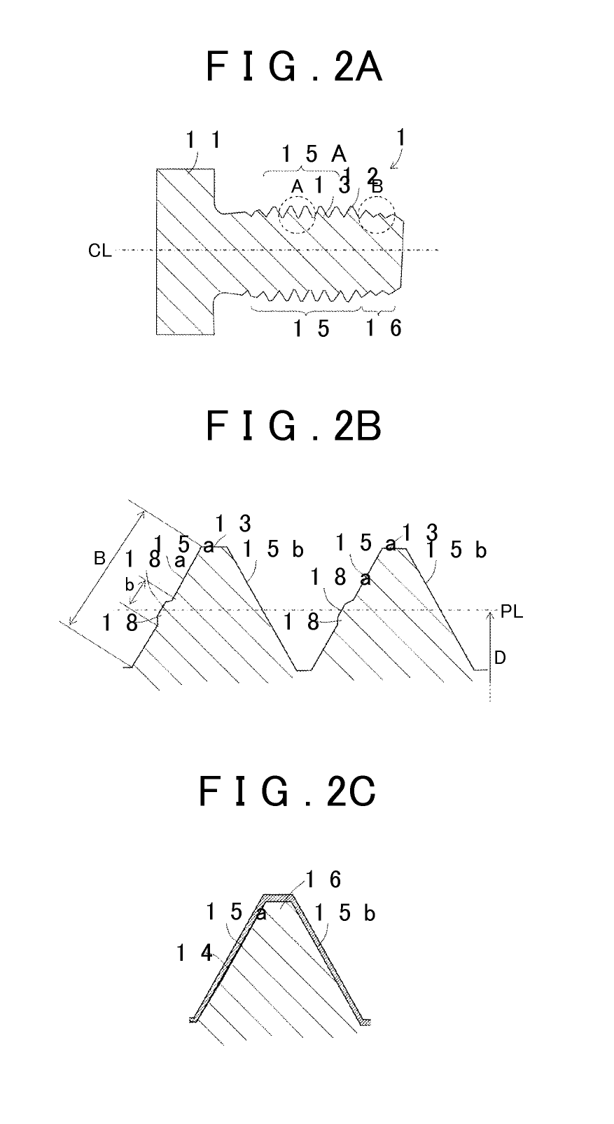

FIG. 1 is a schematic side view of an earth bolt in accordance with Embodiment 1 of the present invention; FIG. 2A is a schematic cross-sectional view of an earth bolt shown in FIG. 1; FIG. 2B is an enlarged view of Part A shown in FIG. 2A; and FIG. 2C is an enlarged view illustrating a part of Part B shown in FIG. 2A.

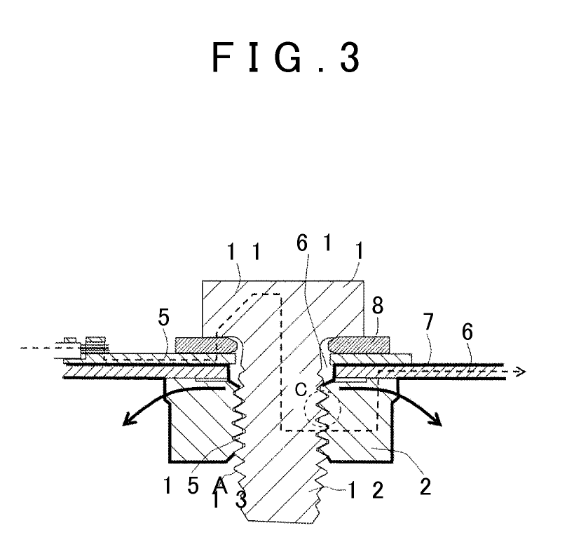

The earth bolt (1) (hereinafter, “bolt”) in accordance with the present embodiment is a bolt to be electrically connected to a nut and an earth terminal by being engaged in the nut so as to position the earth terminal between the bolt and the nut. The bolt (1) is made of materials having electric conductivity such as iron, cast iron, aluminum, copper, titanium, etc. Also, the detailed method of engaging the bolt (1) is described in FIG. 3 below. Further, the term, “earth” used herein has the same meaning as “ground.”

As illustrated in FIG. 1, the bolt (1) has a head (11), and a body (12) extends from the head (11) and forms a thread (13) of an external thread screw-fastened to an internal thread of the nut. The body (12) is formed with a parallel screw (15) from a neck (12a) toward an end of the bolt, and a taper screw (16) is formed closer to the end than the parallel screw (15).

Here, the parallel screw (15) means a screw formed on the external surface of the cylinder, and the taper screw (16) means a screw formed on the external surface of the cone. For example, the top part of the thread (13) of the parallel screw (15) is located on the external surface of a virtual cylinder, and the top part of the taper screw is located on the external surface of a virtual cone. The height of the thread (13) is provided as 5×3^{1/2}×screw pitch/16 from the bottom of the screw, which is the same as the height of general threads.

The parallel screw (15) has an engaging portion (15A) engaged in the nut (2) described below (see FIGS. 3 & 4). Here, as illustrated in FIG. 2B, each thread (13) of the parallel screw (15) is formed by the two spiral flank surfaces (flanks) (15a, 15b) forming a predetermined flank angle. Among the flank surfaces (15a, 15b), the head-facing flank surface (15a) facing the head (11) side is formed with a convex portion (18) along a circumference centering the shaft center (CL) of the body (12) such that the convex portion is protruded from the head-facing flank surface (15a).

The shaft center (CL) of the body (12) here means the rotation axis around which the body rotates when the nut is engaged by the parallel screw (15). In other words, it is the shaft center of the cylinder mentioned above for forming the parallel screw (15). Thus, the convex portion (18) is formed in a spiral together with the head-facing flank surface (15a) in a spiral. Also, the top surface (18a) parallel to the head-facing flank surface (15a) is formed on the convex portion (18) at a position at which the convex portion (18) intersects with the pitch line (PL) of the bolt (1). In the present embodiment, the heights of the top surfaces (18a) of the convex portion (18) from the head-facing flank surface (15a) are all the same, and larger than the thickness (20 μm) of the coating film coated on the nut (2) described below. Thus, it has height such that the convex portion (18) can be elastically deformed without cutting off the flank surface of the nut (2) by the convex portion (18) when the bolt and the nut are engaged.

Also, preferably, the width (b) of the top surface of the convex portion (18) is 5˜50% of the width (B) of the flank surface in the thread direction from the screw bottom. Accordingly, the coating film can be appropriately stripped when the coating film is coated on the screw groove of the nut (2).

Further, a pitch line (PL) is the linear generatrix of a virtual cylinder defining an effective diameter, the effective diameter being the diameter of the virtual cylinder where the width of a thread groove is equal to the width of the thread. In the present embodiment, the convex portion (18) is protruded with respect to the head-facing flank surface (15a) (flat surface) of the screw formed by the effective diameter (D) based on the pitch line (PL).

Also, in case the bolt (1) is engaged in a nut having a coating film formed on the internal thread and the coating film is stripped, in the present embodiment, a concave groove (19) extending to the end (la) of the body (12) from the parallel screw (15) on the end side of the body except for the engaging portion (15A) is formed on the body (12) of the bolt (1) along the shaft center of the body (12). The concave groove (19) has depth, the concave groove (19) extending from the bottom of the thread (13) groove.

Also, on at least the head-facing flank surface (15a) which is closer to the end side of the body than the engaging portion (15A), a hard coating is formed harder than the surface of the nut (2). More specifically, in the present embodiment, as illustrated in FIG. 2C, for example, a hard coating (14) is formed on both of the flank surfaces (15a, 15b) configuring the thread (13) of the taper screw (16). The thickness of the hard coating (14) is preferably a thickness of approximately the coating film coated on the nut. Examples of the hard coating (14) include ceramic coating, amorphous carbon coating, etc.

By forming such hard coating (14), when the bolt (1) is engaged in the nut (2), a part of the coating film coated on the nut can be stripped in advance without cutting off the hard coating (14) coated on the head-facing flank surface (15a) by the nut. Also, the hardness of the hard coating (14) is preferably at least 1.5 times the hardness of the surface of the nut (2) in Vicker's hardness. Accordingly, the coating film can be stripped more surely without cutting off the hard coating (14) by the nut (2).

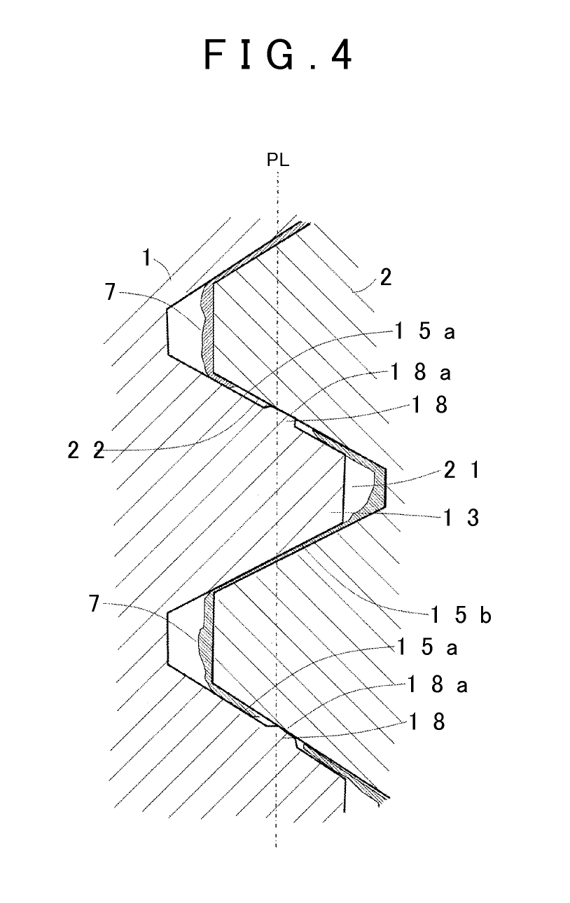

The engaging method using such bolt (1) is explained hereinafter. FIG. 3 is a drawing illustrating the state where an earth bolt shown in FIG. 1 is engaged in a nut. FIG. 4 is an enlarged view of Part C shown in FIG. 3 and shows a cross section of a part of the engaging portion of the earth bolt and the nut.

As illustrated in FIG. 3, the bolt (1) described above is a bolt to be electrically connected to the nut (2) and the earth terminal (5) by being engaged in the nut (2) so as to position the earth terminal (5) between the bolt and the nut (2).

The nut (2) engaged in the bolt (1) is made of metal like the bolt (1), and is welded (deposited) and fixed to a base material (i.e. automobile body) (6) such as a conductive member, etc. like a steel sheet or aluminum sheet, etc. The base material (6) is formed with a penetrating hole (61) consistent with the hole of the nut (2). Also, in the state that the nut (2) is welded to the base material (6), a coating film (7) (bolded line in FIG. 3) is formed on the surface thereof by electro painting.

With regard to the base material (6) where the nut (2) is welded as above, the bolt (1) is engaged in the nut (2) by a torque wrench, etc. so as to interpose the earth terminal (5) via a washer (8) from the side not welded to the nut (2). At that time, as mentioned above, since a coating (14) is formed on the end side (taper) of the bolt (1), the part of the coating film (7) coated on the surface of the screw groove (21) of the internal thread of the nut (2) can be stripped by the hard coating (14). Also, in case the coating film (7) is not coated on the surface of the screw groove of the nut (2), the hard coating (14) does not have to be formed.

In addition, if the bolt (1) is rotated to be tightened by a torque wrench, etc. so as to engage the bolt (1) to the nut (2), a shaft force is applied on the body (12) of the bolt (1) along the direction of the shaft center of the head. At this time, among the flank surfaces (15a, 15b) forming a thread (13), surface pressure from the nut (2) is applied on the head-facing flank surface (15a) facing the head.

In the present embodiment, as mentioned above, the convex portion (18) is formed at a position at which the convex portion (18) intersects with the pitch line (PL) of the bolt (1) on the head-facing flank surface (15a). Accordingly, as illustrated in FIG. 4, regardless of the dimensional tolerance during manufacturing, the convex portion enables the thread (13) of the bolt (1) to surely contact (metal contact) with the screw groove (21) of the nut (2) screw-fastened thereto while stripping the coating film (7) on the part where the thread contacts with the screw groove (21).

Also, since the convex portion (18) is formed along a circumference centering the shaft center (CL) of the body (12) in a position where the convex portion (18) intersects with the pitch line (PL), it is continuously formed in a spiral on a virtual cylinder where the width of the screw groove of the nut (2) becomes equal to the width of the thread (13) of the bolt (1). As a result thereof, the contact area around the shaft center of the body (12) of the bolt (1) can be increased.

Further, since the convex portion (18) is formed with the top surface (18a) parallel to the head-facing flank surface (15a) at a position at which the convex portion (18) intersects with the pitch line (PL), the top surface (18a) of the convex portion (18) of the body (12) of the bolt (1) can be in surface contact with the surface (flank surface) (22) of the screw groove of the nut (2), without excessively cutting off the nut (2) even if the coating film (7) is stripped.

As a result thereof, in the state that the earth terminal (5) is engaged in the nut (2) to be positioned in between the bolt and the nut (2), the resistance of the engaging portion can be reduced by increasing the contact area with the nut (2). Accordingly, a current flowing from the earth terminal (5) flows through the bolt (1), and the current flowing through the bolt (1) may properly flow to the base material (6) through the nut (see broken line arrow in FIG. 3).

Also, in the present embodiment, a concave groove portion (19) is formed on the body (12) along the direction of the shaft center of the body (12), the concave groove portion extending to the end of the body (12). Accordingly, when the bolt (1) is engaged in the nut, the coating film (7) formed on the internal thread of the nut (2) can be stripped by the hard coating (14) and the convex portion (18), and the stripped coating film (7) can be discharged towards the body end of the bolt (1) from the concave groove (19).

### Embodiment 2

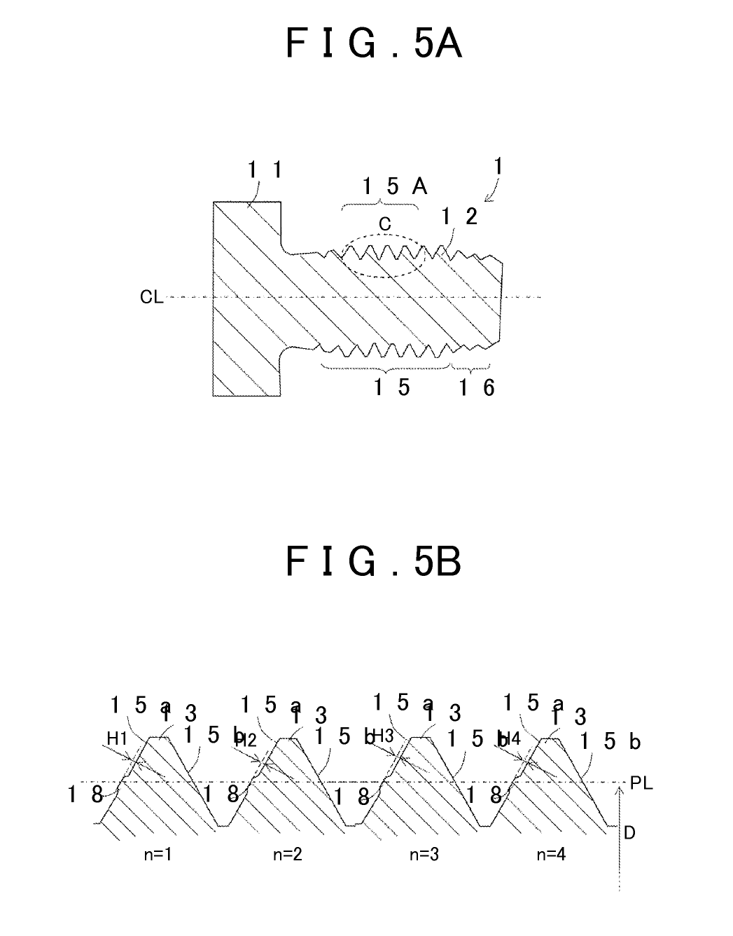

FIG. 5A is a schematic cross-sectional view of an earth bolt in accordance with Embodiment 2 of the present invention. FIG. SB is an enlarged view of Part C shown in FIG. 5A. The present embodiment differs from Embodiment 1 in the height to top of the convex portion. Thus, in the present embodiment, the same reference numerals are used for the parts having the same function as the bolt in Embodiment 1, and the detailed explanation on them are omitted.

However, the inventors found that, as illustrated in FIG. 3, in case of adopting the engaging method for engaging the bolt to the nut (2) so as to position the base material (6) and the earth terminal (5) between the bolt and the nut (2), the nut (2) in the engaged state bends as a whole in the direction of the thick-lined arrow. Thus, the hole of the nut (2) in the engaging surface side slightly increases.

Therefore, as the nut proceeds to the head (11) side of the bolt (1), the surface pressure is applied on the head-facing flank surface (15a) of the thread (13) of the bolt (1) gets smaller (as the load share of the load being applied in the direction of the shaft center gets smaller). Thus, the contact between the bolt (1) and nut (2) becomes unstable.

In light of the above, as illustrated in FIG. 5B, in the present embodiment, the height of the convex portion (18) from the head-facing flank surface (15a) increases as it proceeds to the head (11) side of the bolt (1). That is, the height of the convex portion (18) from the head-facing flank surface (15a) is formed in such a manner that the height of the convex portion (18) from the head-facing flank surface (15a) which is in the side of bolt head (11) is higher than the height of the convex portion from the head-facing flank surface which is in the opposite side direction of the side of the bolt head.

Specifically, as an example of the present invention, when Hn is a height of a convex portion which is nth from the head and the height is measured form the head-facing flank surface (15a), the height Hn satisfies the following equation:

Hn=½H1+(N−n)×H1/[2(N−1)] (Equation 1).

Here, N is the total number of threads (13) of the engaging portion (15A) formed with the convex portion (18), and H1 is the height of the (first) convex portion (18) of the engaging portion (15A) closest to the head (11). For example, in case where there are 4 threads and the H1=20 mm, H2=16.7 mm, H3=13.3 mm, and H4=10 mm.

As such, in the state that the bolt (1) is engaged in the nut so as to position the earth terminal (5) between the bolt (1) and the nut (2), even if the nut in the engaged state bends as a whole, and the hole of the nut at the engaging surface side slightly increases, the surface pressure being applied on the head-facing flank surface (15a) of the thread (13) of the bolt (1) can be equalized by forming the convex portions (18) having a height as mentioned in the above. Accordingly, the state in which the bolt (1) and the nut (2) are contacted can be stabilized.

Hereinafter, the present invention is explained with reference to examples.

### Example 1

As a bolt in accordance with Example 1, a bolt corresponding to Embodiment 1 is manufactured. Specifically, a material made of carbon steel (S45C) is prepared. M6 bolt is manufactured by form rolling a thread on the body such that its pitch is 1 mm, its effective diameter is 5.3 mm, the height of the convex portion is 35 μm, and the width of the convex portion is 200 μm.

### Comparative Example 1

A bolt having the same diameter and pitch as in Example 1 was manufactured. The difference from Example 1 is that protrusions protruding outward are formed on the flank surface near the top part of the thread formed on the body, like the bolt in JP 2001-173627 A.

<Confirmation of the Engaged State>

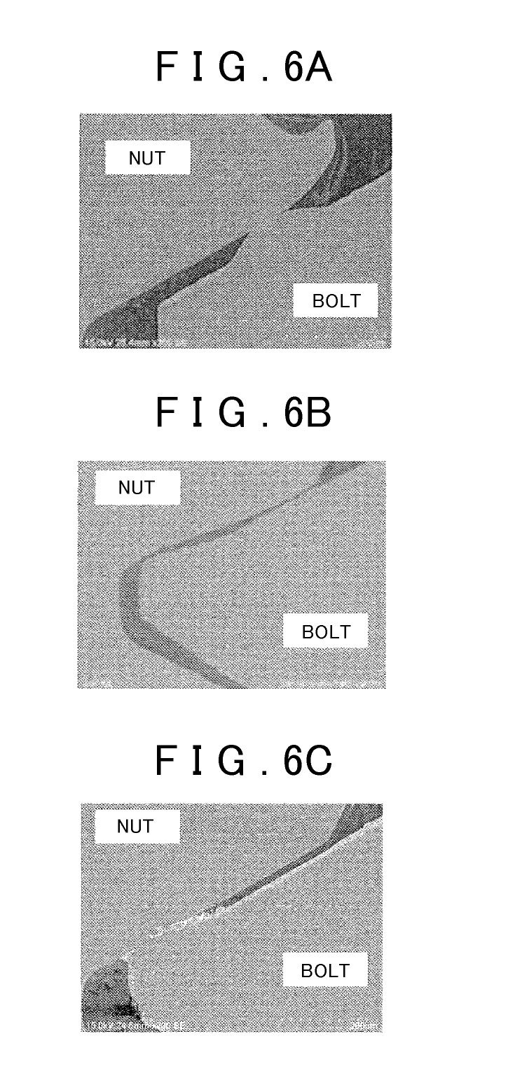

By using the bolts in accordance with Example 1 and Comparative Example 1, as illustrated in FIG. 3, a steel plate is prepared having a nut welded thereon and forming a coating film thereon, and the bolt is engaged in the nut at a condition of a torque of 7 N/m. Accordingly, the state of contacting is confirmed. The results are shown in FIG. 6A-FIG. 6C. FIG. 6A is a photograph of a state that a bolt and a nut are engaged according to Example 1. FIG. 6B is a photograph of a state that a bolt and a nut are engaged according to Comparative Example 1. FIG. 6C is a photograph of a state that a bolt and a nut are engaged at a position different from the position shown in FIG. 6B.

In case of the bolt in accordance with Example 1, as illustrated in FIG. 6A, the bolt and the nut are in surface contact with the convex portion, but in case of Comparative Example 1, as illustrated in FIG. 6B, there are points where the bolt and the nut are not in surface contact with the protrusion. Also, in the case of Comparative Example 1, since a protrusion is formed near the top part of the thread, the dimensional tolerance thereof is high. Also, as illustrated in FIG. 6C, there are cases where the nut is cut off by the protrusion. As a result thereof, there may be points where the bolt and the nut are not in surface contact with the protrusions, as illustrated in FIG. 6B.

<Confirmation of Resistance>

Bolts in accordance with Example 1 and Comparative Example 1, and bolts where the convex portions are not formed on the flank surface as compared to Example 1 as Reference Example 1 are prepared. These bolts are engaged in the nuts coated with a coating film under the same condition as described above. A current of 10 A is applied between the bolt and the nut, and the resistance thereof is measured. The result is shown in Table 1.

TABLE 1

| | | Comparative | Reference |
|---|---|---|---|
| | Example 1 | Example 1 | Example 1 |
| Resistance (Ω) | 0.21 mΩ | 0.25 mΩ | at least 3 mΩ |

From the above results, the bolt of Example 1 showed the smallest resistance. The bolt of Comparative Example 1 has a resistance higher than that in Example 1 because the bolt of Comparative Example 1 has a point not in surface contact with the protrusions as described above. Also, the bolt of Reference Example 1 has a resistance higher than that in Example 1 because the coating film formed on the nut cannot be sufficiently stripped by the bolt.

The embodiments of the invention have been described so far, but the invention is not limited to the embodiments and can be carried out in various modifications without deviating from the spirit and scope of the invention.

Also, although the concave groove in accordance with Embodiment 1 and Embodiment 2 is formed down to the end of the body from the engaging portion so as not to include the engaging portion, if the function of the convex portion described above is not inhibited, a concave groove may be formed within a scope including the engaging portion.

In the present embodiment, in a state where the nut is welded on the base material (body), an aspect of engaging the bolt to the nut coated with a coating film is exemplified. However, if it is a structure applying a current to the engaging portion of the nut and bolt by engaging the bolt and the nut, the aspect shall not be particularly limited to the above.

What is claimed is:

1. An earth bolt for coming into electrical contact with a nut by being engaged in the nut, the earth bolt comprising:
a head; and
a body extending from the head, the body having threads of an external thread formed on the body and screw-fastened to an internal thread of the nut, wherein
flank surfaces are formed on the thread,
a convex portion is formed on a head-facing flank surface, the head-facing flank surface facing the head, along a circumference centering a shaft center of the body in such a manner that the convex portion is protruded from the head-facing flank surface, and
a top surface parallel to the head-facing flank surface is formed on the convex portion in a position where the convex portion interacts with a pitch line of the earth bolt.

2. The earth bolt according to claim 1, wherein a height of the convex portion from the head-facing flank surface is formed in such a manner that a height of the convex portion from a head-facing flank surface which is in the side of the bolt head is higher than a height of the convex portion from a head-facing flank surface which is in the opposite side direction of the side of the bolt head.

3. The earth bolt according to claim 1, wherein when Hn is a height of a convex portion which is nth from the head and the height is measured from the head-facing flank surface, the height Hn satisfies the following equation: Hn=½H1+(N−n)×H1[2(N−1)], wherein N is a total number of threads of an engaging portion formed with the convex portion, H1 is the height of the convex portion of the engaging portion closest to the head.

4. The earth bolt according to claim 1, wherein the earth bolt strips a coating film formed on the internal thread of the nut while it is engaged in the nut, and the height of the convex portion from the head-facing flank surface is greater than a thickness of the coating film.

5. The earth bolt according to claim 4, wherein a concave groove portion is formed on the body along the direction of the shaft center of the body, the concave groove portion extending to an end of the body.

6. The earth bolt according to claim 5, wherein the concave groove portion extends from a parallel thread portion on the end side of the body except for the engaging portion to the end of the body.

7. The earth bolt according to claim 4, wherein a hard coating harder than the nut is formed on at least the head-facing flank surface which is closer to the end side of the body than the engaging portion to be engaged in the nut.

8. The earth bolt according to claim 1, wherein the pitch line is a linear generatrix of a virtual cylinder defining an effective diameter, the effective diameter being a diameter of the virtual cylinder where a width of a thread groove is equal to a width of the thread.
